(19) United States
(12) Patent Application Publication
(10) Pub. No.: US 2015/0072581 A1
(43) Pub. Date: Mar. 12, 2015

(54) Nanocellulose Composites and Methods for their Preparation and Use

(71) Applicant: Empire Technology Development LLC, Wilmington, DE (US)

(72) Inventor: Sivaraman Raghu, Chennai (IN)

(73) Assignee: Empire Technology Development LLC, Wilmington, DE (US)

(21) Appl. No.: 14/481,439

(22) Filed: Sep. 9, 2014

(30) Foreign Application Priority Data
Sep. 11, 2013 (IN) 4051/CHE/2013

(51) Int. Cl. B65D 65/42; B65D 5/56; C08K 3/36; C08K 3/34; C09D 153/00

(52) U.S. Cl. CPC B65D 65/42; C08K 3/346; C09D 153/00; C08K 3/36; B65D 5/563
USPC 442/80; 524/445; 525/54.23; 428/535

(57) ABSTRACT

Methods of forming a nanocellulose composite are provided. The methods can include blending a copolymer with a nanocellulose to form the nanocellulose composite. The copolymer can be a reaction product of a first monomer, a second monomer, and a third monomer. The first monomer is a hydrophilic monomer, the second monomer is a cellulose-reactive monomer and the third monomer is an amphiphobic monomer.

### BACKGROUND

Paper and kraft paper are used as packaging materials for industrial, consumer and food products. Many packaging materials are provided with a barrier, for example, a water or oil resistant barrier that makes the packaging material resistant towards liquids and/or oil. Typically, such barriers are formed by coating a packaging substrate (such as paper) with a composition that provides the substrate with barrier properties. A variety of barrier coatings can be applied to the packaging substrate. However, such barrier coatings may involve expensive compositions. Some packaging materials use paper along with polymer films and aluminum foils as multi-laminates. However, such materials can be difficult to recycle as each layer needs to be separated before recycling.

Further, packaging materials use wax coating for certain applications. Such coatings may not provide strength characteristics to the paper required for long-term storage or rough handling.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Briefly, in accordance with one aspect, a method of forming a nanocellulose composite is provided. The method includes blending a copolymer with a nanocellulose to form the nanocellulose composite. The copolymer is a reaction product of a first monomer, a second monomer, and a third monomer. The first monomer is a hydrophilic monomer, the second monomer is a cellulose-reactive monomer and the third monomer is an amphiphobic monomer.

In accordance with another aspect, a nanocellulose composite is provided. The nanocellulose composite includes a copolymer covalently bonded to a nanocellulose. The copolymer is a reaction product of a first monomer, a second monomer, and a third monomer. The first monomer is a hydrophilic monomer, the second monomer is a cellulose-reactive monomer and the third monomer is an amphiphobic monomer.

In accordance with another aspect, a method of forming a coated packaging material is provided. The method includes providing a nanocellulose composite. The method also includes at least partially coating a substrate with the nanocellulose composite and drying the coated substrate to form the coated packaging material. The nanocellulose composite includes a copolymer covalently bonded to a nanocellulose. The copolymer is a reaction product of a first monomer, a second monomer, and a third monomer. The first monomer is a hydrophilic monomer, the second monomer is a cellulose-reactive monomer and the third monomer is an amphiphobic monomer.

In accordance with another aspect, a coated packaging material is provided. The coated packaging material includes a substrate at least partially coated with a copolymer covalently bonded to a nanocellulose. The copolymer is a reaction product of a first monomer, a second monomer, and a third monomer. The first monomer is a hydrophilic monomer, the second monomer is a cellulose-reactive monomer and the third monomer is an amphiphobic monomer.

### BRIEF DESCRIPTION OF THE FIGURES

FIG. 1 is an example flow diagram of an embodiment of a method of forming a nanocellulose composite.

FIG. 2 is an example packaging material.

FIG. 3 is an example flow diagram of an embodiment of a method of forming a coated packaging material.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will also be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof. While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Some embodiments are generally directed to techniques of forming nanocellulose composites that can be used as coatings for substrates such as paper to form packaging materials having substantially high resistance to moisture and oil. The embodiments described below provide a simple and cost effective coating treatment for substrates such as paper and fabrics with the proposed nanocellulose composite that enhances the wet strength and tensile strength of the substrates. The present techniques of forming the packaging materials are scalable and are adaptable for manufacturing. The nanocellulose composite coated on the substrates enhances the barrier properties of the substrates. Further, such materials do not contain bisphenol A (BPA) and can be used as food packaging materials that are biodegradable.

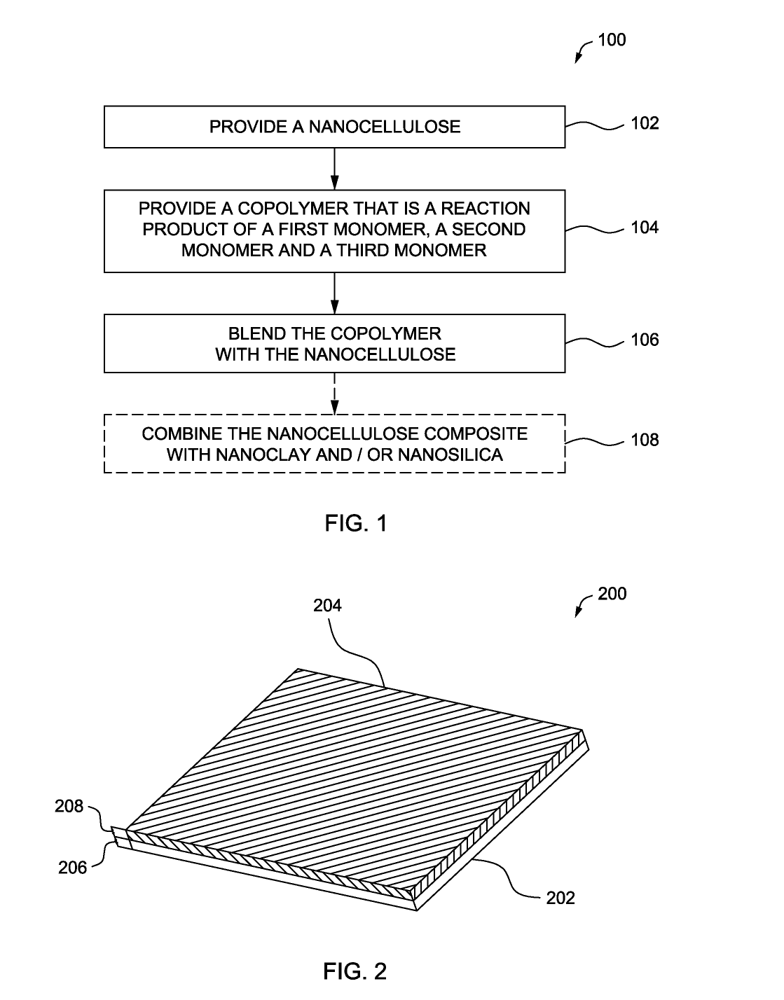

Referring now to FIG. 1, an example flow diagram 100 of an embodiment for a method of forming a nanocellulose composite is provided. At block 102, a nanocellulose is provided. The nanocellulose is readily available from natural sources such as cellulose pulp. Further, at block 104, a copolymer is provided. In this example embodiment, the copolymer is a reaction product of a first monomer, a second monomer, and a third monomer. In one example, the first monomer is a hydrophilic monomer, the second monomer is a cellulose-reactive monomer and the third monomer is an amphiphobic monomer.

Examples of the first monomer include, but are not limited to, acrylic ethoxylated ester, methaacrylic ethoxylated ester, methyacrylate/methacrylate copolymer, itaconic anhydride/methacrylate copolymer, maleic anhydride/methacrylate copolymer, glycidyl acrylate/methacrylate, hydroxylmethyl/hydroxylethyl styrene, or combinations thereof. In one example embodiment, the first monomer is present in the copolymer at a concentration of about 20 weight % to about 30 weight %. Specific examples of the concentration of the first monomer include about 20 weight %, about 21 weight %, about 22 weight %, about 23 weight %, about 24 weight %, about 25 weight %, about 26 weight %, about 27 weight %, about 28 weight %, about 29 weight %, about 30 weight % and ranges between any two of these values (including endpoints).

In some embodiments, the second monomer is hydrophobic. Examples of the second monomer include, but are not limited to, an alkoxy silane, a silyl acrylate, acrylic ethoxylated ester, methacrylic ethoxylated ester, methyacrylate/methacrylate copolymer, itaconic anhydride/methacrylate copolymer, maleic anhydride/methacrylate copolymer, styrene/substituted styrene, acrylonitrile, vinyl acetate, or combinations thereof. In one example embodiment, the second monomer is present in the copolymer at a concentration of about 20 weight % to about 30 weight %. Specific examples of the concentration of the second monomer include about 20 weight %, about 21 weight %, about 22 weight %, about 23 weight %, about 24 weight %, about 25 weight %, about 26 weight %, about 27 weight %, about 28 weight %, about 29 weight %, about 30 weight % and ranges between any two of these values (including endpoints).

Examples of the third monomer include, but are not limited to, fluoroalkyl acrylate, 2-trifluoromethyl ethyl acrylate, perfluoro C2-C6 alkyl acrylate, trifluoro ethyl acrylate, trifluorobutyl acrylate, or combinations thereof. In one example embodiment, the third monomer is present in the copolymer at a concentration of about 40 weight % to about 50 weight %. Specific examples of the concentration include about 40 weight %, about 41 weight %, about 42 weight %, about 43 weight %, about 44 weight %, about 45 weight %, about 46 weight %, about 47 weight %, about 48 weight %, about 49 weight %, about 50 weight % and ranges between any two of these values (including endpoints).

At block 106, the copolymer is blended with the nanocellulose to form a nanocellulose composite. Here, the copolymer covalently binds to the nanocellulose to form the nanocellulose composite. In particular, the second monomer present in the copolymer covalently binds to the nanocellulose. In one example, the nanocellulose is present in the nanocellulose composite at a concentration of about 5 weight % to about 10 weight %. Specific examples of the concentration of the nanocellulose include about 5 weight %, about 6 weight %, about 7 weight %, about 8 weight %, about 9 weight %, about 10 weight % and ranges between any two of these values (including endpoints). In another embodiment, the copolymer is present in the nanocellulose composite at a concentration of about 1 weight % to about 5 weight %. Specific examples of the concentration of the copolymer include about 1 weight %, about 2 weight %, about 3 weight %, about 4 weight %, about 5 weight % and ranges between any two of these values (including endpoints).

Further, at block 108, the nanocellulose composite is combined with nanoclay and/or nanosilica to form a sol-gel-matrix that can be sprayed on a substrate such as paper. The coating of such sol-gel-matrix enhances the resistance of the substrate to moisture and oil and substantially enhances barrier properties of the substrate. It should be noted that since the sol-gel-matrix is formed using nano sized particles of cellulose, silica and the copolymer, the layers are thin and unimolecular. In some examples, active materials such as biocides, antibacterial agents can be incorporated to prevent mold and mildew formation during long storage of such coating materials. In some examples, the nanocellulose composite is coated on fabric such as cotton, jute, silk, wool, polyester, linen, nylon and velvet thereby protecting such fabrics from dirt and stains. The packaging materials described above can repeatedly be used owing to the strength provided by the nanocellulose material.

As described above, the first monomer of the copolymer facilitates anchoring of the copolymer to the nanocelluose. Further, the second monomer of the copolymer covalently binds to the nanocellulose to render the surface hydrophobic and the third monomer provides amphiphobicity. The nanocellulose composites described above provide substantial resistance to moisture and oil and enhances the impact and the tensile strength of the substrate coated with such nanocellulose composites.

Referring now to FIG. 2, an example packaging material 200 is illustrated. The packaging material 200 includes a substrate 202 coated with a nanocellulose composite 204 such as formed using the example process of FIG. 1. Examples of the substrate 202 includes, but are not limited to, paper, kraft paper, fabric, or combinations thereof. In one example, the substrate 202 includes cotton, silk, jute, or combinations thereof. Other suitable materials may be used for the substrate 202. In one example, the substrate 202 is flexible. In some examples, a thickness 206 of the substrate 202 is about 0.1 mm to about 10 mm.

The substrate 202 is at least partially coated with the nanocellulose composite 204. In the illustrated embodiment, the substrate 202 is fully coated with the nanocellulose composite 204. In this embodiment, the nanocellulose composite 204 includes a copolymer covalently bonded to a nanocellulose. The copolymer is a reaction product of a first monomer, a second monomer, and a third monomer. In some examples, a thickness 208 of the nanocelluloase composite 204 coated on the substrate 202 is about 10 micrometers (μm) to about 1 millimeter (mm).

Examples of the first monomer include, but are not limited to, acrylic ethoxylated ester, methaacrylic ethoxylated ester, methyacrylate/methacrylate copolymer, itaconic anhydride/methacrylate copolymer, maleic anhydride/methacrylate copolymer, glycidyl acrylate/methacrylate, hydroxylmethyl/hydroxylethyl styrene, or combinations thereof. Examples of the second monomer include, but are not limited to, an alkoxy silane, asilyl acrylate, acrylic ethoxylated ester, methaacrylic ethoxylated ester, methyacrylate/methacrylate copolymer, itaconic anhydride/methacrylate copolymer, maleic anhydride/methacrylate copolymer, styrene/substituted styrene, acrylonitrile, vinyl acetate, or combinations thereof. Examples of the third monomer include, but are not limited to, fluoroalkyl acrylate, 2-trifluoromethyl ethyl acrylate, perfluoro C2-C6 alkyl acrylate, trifluoro ethyl acrylate, trifluorobutyl acrylate, or combinations thereof.

In some embodiments, nanoclay and/or nanosilica is mixed with the nanocellulose composite 204. In certain embodiments, the nanocellulose composite 204 includes nanoclay present at a concentration of about 1 weight % to about 5 weight %. Specific examples of the concentration of nanoclay include about 1 weight %, about 2 weight %, about 3 weight %, about 4 weight %, about 5 weight % and ranges between any two of these values (including endpoints). In certain other embodiments, the nanocellulose composite 204 includes nanosilica present at a concentration of about 1 weight % to about 5 weight %. Specific examples of the concentration of nanosilica include about 1 weight %, about 2 weight %, about 3 weight %, about 4 weight %, about 5 weight % and ranges between any two of these values (including endpoints).

In some examples, a weight ratio of the nanocellulose to the copolymer in the nanocellulose composite 204 is in the range of about 1:1 to about 10:1. Specific examples of the weight ratio include about 1:1, about 2:1, about 3:1, about 4:1, about 5:1, about 6:1, about 7:1, about 8:1, about 9:1, about 10:1 and ranges between any two of these values (including endpoints).

A variety of copolymers can be used to form the nanocellulose composite 204. In one example, the copolymer is an acrylic. One example structure for the first monomer used in the acrylic is depicted by Formula 1.

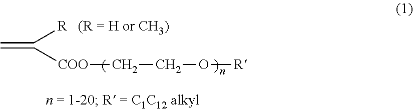

Other example structures for the first monomer are as depicted by Formulae 2, 3, and 4.

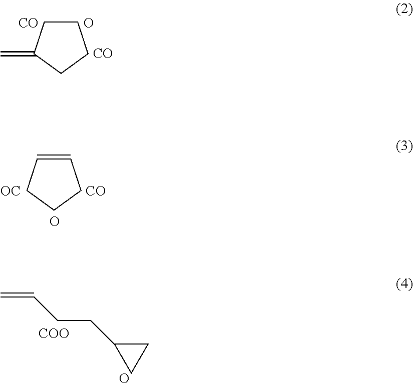

In one example embodiment, the acrylic or methacrylic ethoxylated ester copolymer is prepared from methyl acrylate and ethoxylated alcohol by either ester exchange or through the acid chloride. Alternatively, glycydyl methacrylate or itaconic anhydride or maleic anhydrides are also copolymerized with methacrylate. These groups chemically react with nanocellulose to form bonds.

In this embodiment, an example structure for the second monomer used in the acrylic is depicted below by Formula 5.

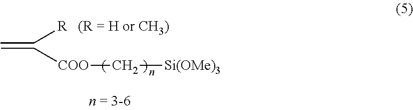

In one example embodiment, the amphiphobic second monomer is derived from alkyl silyl acrylates.

Moreover, example structures for the third monomer used in the acrylic are depicted below by Formulae 6 and 7.

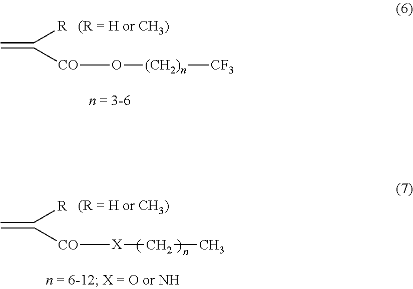

In one example embodiment, the hydrophobic third monomer is derived from fluoroalkyl of alkyl acrylates with carbon chains of about 6 to about 12 carbons. Alternatively, in another embodiment, the third monomer is derived from simple styrene or substituted styrene. The copolymers are prepared by polymerizing each of the first monomer, second monomer and the third monomer in succession, which is subsequently dissolved and precipitated under shear to give nano-sized particles.

In another example embodiment, the copolymer is a polyester. One example structure for the first monomer used in the polyester is as depicted below by Formula 8.

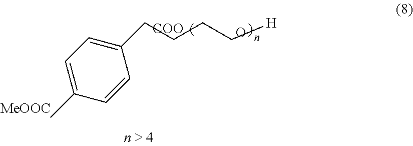

In this embodiment, an example structure for the second monomer used in the polyester is depicted below by Formula 9.

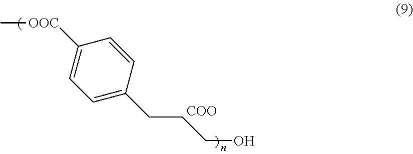

Further, an example structure for the third monomer used in the polyester is depicted below by Formula 10.

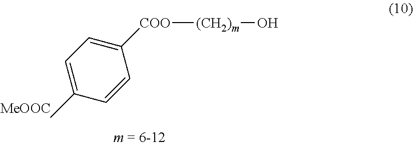

In one example embodiment, dimethyl terephthalate as ester is exchanged with poly ethylene glycol to form the first monomer, with ethylene glycol to form the second monomer and α-ω diols to form the third monomer which are then condensed to form the copolymer polyster.

In a further embodiment, the copolymer is a polyurethane. In one example, the copolymer includes polyethylene oxide urethane, silicone urethane and an alkyl urethane that provide amphiphobic properties to the copolymer. One example structure for the first monomer used in the polyurethane is as depicted below by Formula 11.

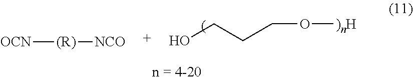

In this embodiment, an example structure for the second monomer used in the polyurethane is depicted below by Formula 12.

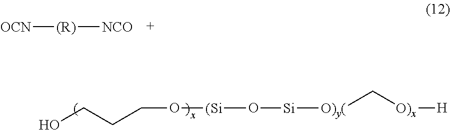

In this embodiment, an example structure for the third monomer used in the polyurethane is depicted below by Formula 13.

OCN—(R)—NCO+HO(CH₂)ₘ—OH (13)
m=6-16

In each of the above-described copolymers, the ratios of the first monomer, the second monomer and the third monomer may be selected to achieve desired characteristics of the coating material formed using the copolymers. Such materials act as cost-effective amphiphobic coatings that provide resistance to moisture and oil and enhance the impact and tensile strength of the packaging materials formed using the coating material described above.

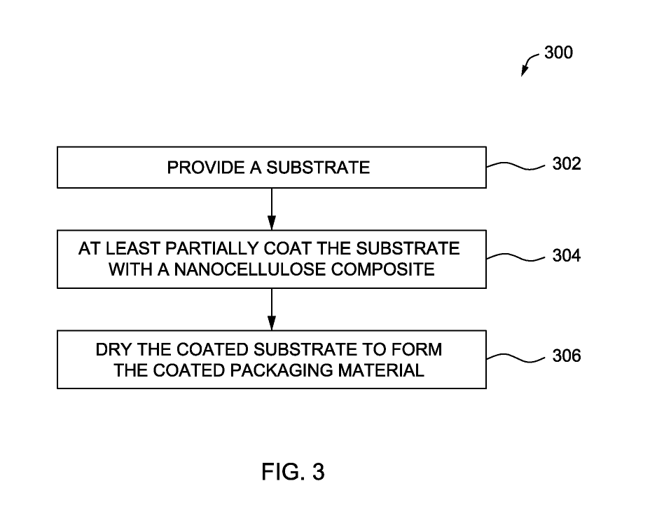

Referring now to FIG. 3, an example flow diagram 300 of an embodiment for a method of forming a coated packaging material is provided. At block 302, a substrate is provided. In one example, the substrate is flexible. Examples of the substrate include, but are not limited to, paper, kraft paper, fabric, or combinations thereof. At block 304, the substrate is at least partially coated with a nanocellulose composite formed using the process of FIG. 1. As described above, the nanocellulose composite includes a copolymer covalently bonded to a nanocellulose. The copolymer is a reaction product of a first monomer, a second monomer, and a third monomer. Here, the first monomer is a hydrophilic monomer, the second monomer is a cellulose-reactive monomer and the third monomer is an amphiphobic monomer. In some example embodiments, the substrate is fully coated with the nanocellulose composite.

In some embodiments, the nanocellulose composite is deposited on the substrate at an elevated temperature, such as a temperature of about 50° C. to about 80° C. The nanocellulose composite may be deposited on the substrate using known deposition techniques. Specific examples of the temperature include about 50° C., about 55° C., about 60° C., about 65° C., about 70° C., about 75° C., about 80° C., and ranges between any two of these values (including endpoints). Further, at block 306, the coated substrate is dried to form the coated packaging material. In some embodiments, the coated substrate is dried at an elevated temperature, such as a temperature of about 80° C. to about 100° C. Specific examples of the temperature include about 80° C., about 85° C., about 90° C., about 95° C., about 100° C. and ranges between any two of these values (including endpoints). The dried coated substrate is subsequently further dried at ambient temperatures.

The coated packaging material described above has a relatively higher tensile strength as compared to non-coated kraft paper. For example, the coated packaging material can have a relatively higher tensile strength of about 15% to about 50% as compared to non-coated kraft paper. Specific examples of relative increase in tensile strength include, about 15%, about 20%, about 25%, about 30%, about 35%, about 40%, about 45%, about 50% and ranges between any two of these values (including endpoints). Further, the coated packaging material has a relatively higher wet strength as compared to non-coated kraft paper. For example, the coated packaging material can have a relatively higher wet strength of about 30% to about 50% as compared to non-coated kraft paper. Specific examples of relative increase in wet strength include, about 30%, about 35%, about 40%, about 45%, about 50% and ranges between any two of these values (including endpoints). In one example embodiment, the coated packaging material has a tensile strength of about 40 pounds per square inch (lbs/in²) to about 50 lbs/in² (i.e., about 2.8 kg/cm² to about 3.5 kg/cm²) for about 120 pounds (lb) to about 140 lb (i.e. about 54.5 kg to about 63.5 kg) of weight kraft paper.

### EXAMPLES

The present invention will be described below in further detail with examples and comparative examples thereof, but it is noted that the present invention is by no means intended to be limited to these examples.

### Example 1

### Formation of a Coated Packaging Material

A nanocellulose composite was formed by blending about 10 weight % nanocellulose suspension with about 1 weight % copolymer. The nanocellulose composite also included nanoclay and/or nanosilica, clay water and surfactants. Here, nanoclay and/or nanosilica of about 2 weight % to about 5 weight % were added to the mixture. Further, a surfactant (about 0.1 weight % to about 1.0 weight %) was added to form an uniform dispersion The nanocellulose composite thus formed was sprayed on to a paper or kraft sheets at a temperature of about 50° C. to about 80° C. The paper with the nanocellulose composite coating was then dried using an air drier at a temperature of about 80° C. to about 100° C. The dried sheets were subsequently allowed to further dry at ambient temperatures. Some of the copolymers described above i.e., PEG-methacrylate copolymer, poly trimthoxysilyl propyl methacrylate-polybutyl methacrylate terpolymer (PolyTEGMMEM), polyster copolymer and polyurethanes copolymer were formed as described below.

### Example 2

### Formation of PEG-Methacrylate Copolymer

A mixture of about 10 grams (g), 0.1 mole of methyl methacrylate in toluene, about 20.8 g, 0.1 mole of tetraethylene glycol mono methyl ether and about 0.2 g of paratoluene sulfonic acid was prepared. The mixture was heated to a temperature of about 90° C. and was maintained at that temperature until about 12 milliliter (ml) of methanol-toluene azeotrope was collected. The solvent was evaporated under reduced pressure conditions to form a viscous liquid. This viscous liquid was dissolved in methylene chloride and was washed with about 5 weight % sodium bicarbonate solution and was subsequently dried. Further, the solvent was removed to form about 25 g of tetraethylene glycol monomethyl ether methacrylate (TEGMMEM).

### Example 3

### Formation of Poly Trimthoxysilyl Propyl Methacrylate-Polybutyl Methacrylate Terpolymer (PolyTEGMMEM)

A mixture of about 1 g of ferrous chloride tetrahydrate bis triphenylphosphine {FeCl₂.4H₂O.(PPh₃)₂} and about 100 ml of acetone was prepared. This mixture was purged with nitrogen for a time period of about 10 minutes. The formed solution was then heated to a temperature of about 70° C. under nitrogen atmosphere. Further, about 0.5 g of 2-bromo propionate was added to the solution followed by about 13 g of TEGMMEM in about 20 ml of acetone over a time period of about 10 minutes. In addition, about 12 g of silyl acrylate in about 20 ml of acetone was added to the solution followed by addition of about 10 g of butyl methacrylate in about 20 ml of acetone while maintaining the same reaction temperature. The solution was stirred under nitrogen atmosphere for a time period of about 20 minutes, and was subsequently cooled to room temperature. The solution was then filtered through about 10 g of silica gel. The obtained filtrate was stirred rapidly and about 100 ml of heptane was added to the filtrate. The precipitated copolymer was then filtered and dried.

### Example 4

### Formation of a Triblock Polyester Copolymer

A mixture of about 19.4 g, 0.1 mole of dimethyl terephthalate in about 200 ml toluene, about 1 g of paratolene sulfonic acid and about 40 g, 0.02 mole of polyethylene glycol (PEG) 2000 was prepared. This mixture was heated to a temperature of about 100° C. to about 120° C. and about 10 ml of methanol-toluene azeotrope was collected over a time period of about 6 hours. Further, about 4 g of ethylene glycol was added to the reaction flask and about 20 ml of azeotrope was collected over a time period of about 4 hours. Subsequently, about 2 g of butylene glycol was added and another about 10 ml of distillate was collected. The mixture was then cooled to a temperature of about 40° C. and the solvent was removed under reduced pressure conditions. Moreover, the obtained residue was dissolved in about 100 ml of ethyl acetate, was washed with about 5% sodium bicarbonate solution while stirring the residue at high speeds. Then about 200 ml hexane was added to precipitate polyester copolymer. The precipitate was collected and dried.

### Example 5

### Formation of a Triblock Polyurethanes Copolymer

A solution of about 17.4 g, 0.1 mole of toluene diisocyanate (TDI) in about 200 ml of methylene chloride was prepared. This solution was cooled to a temperature of about 0° C. to about 5° C. using an ice bath. Further, about 2.0 g of triethylaamine followed by about 40.0 g, 0.02 moles of PEG 2000 was added to the solution. The mixture was stirred for a time period of about 30 minutes, and about 0.2 mole of hydroxyl terminated ethoxylated silicone was added to the mixture at a temperature of about 0° C. to about 5° C. The stirring was continued for a time period of about 30 minutes. Further, about 5.4 g, 0.6 moles of 1,4 butylene glycol was added to the mixture and was maintained at room temperature. The mixture was washed with about 1% acetic acid solution and dried. Further, hexane was added to the mixture while stirring the solution and the precipitated polymer was filtered and dried to form the polyurethanes copolymer. The above-described process was repeated with combinations of different diisocyanates, different molecular weight PEGs, dihydroxyl silicones and diols to form various copolymers.

### Example 6

### Prophetic Example of Properties of the Coated Packaging Material

The strength and barrier properties of the coated packaging material formed using the process described above may be evaluated. The coated packaging material formed by coating kraft paper with the nanocellulose composite is observed to be uniform and coherent in nature. Furthermore, the paper coated with the nanocellulose composite has enhanced strength and barrier properties relative to non-coated Kraft paper.

The coated packaging material formed using the process described in Example 1 has a relatively higher tensile strength of about 15% to about 50% and a relatively higher wet strength of about 30% to about 50% as compared to non-coated kraft paper. In one example, the coated packaging material of about 120 pounds (lb) to about 140 lb of weight has a measured tensile strength of about 40 pounds per square inch (lbs/in²) to about 50 lbs/in².

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of forming a nanocellulose composite, the method comprising:
blending a copolymer with a nanocellulose to form the nanocellulose composite, wherein:
the copolymer is a reaction product of a first monomer, a second monomer, and a third monomer;
the first monomer is a hydrophilic monomer;
the second monomer is a cellulose-reactive monomer; and
the third monomer is an amphiphobic monomer.

2. The method of claim 1, further comprising covalently binding the copolymer or the second monomer to the nanocellulose.

3. (canceled)

4. The method of claim 1, wherein the first monomer is acrylic ethoxylated ester, methacrylic ethoxylated ester, methacrylate/methacrylate copolymer, itaconic anhydride/methacrylate copolymer, maleic anhydride/methacrylate copolymer, glycidyl acrylate/methacrylate, hydroxyl methyl/hydroxylethyl styrene, or combinations thereof.

5. The method of claim 1, wherein the second monomer is hydrophobic.

6. The method of claim 1, wherein the second monomer is an alkoxy silane, asilyl acrylate, acrylic ethoxylated ester, methacrylic ethoxylated ester, methacrylate/methacrylate copolymer, itaconic anhydride/methacrylate copolymer, maleic anhydride/methacrylate copolymer, styrene/substituted styrene, acrylonitrile, vinyl acetate, or combinations thereof.

7. The method of claim 1, wherein the third monomer is a fluoroalkyl acrylate, 2-trifluoromethyl ethyl acrylate, perfluoro C2-C6 alkyl acrylate, trifluoro ethyl acrylate, trifluorobutyl acrylate, or combinations thereof.

8-9. (canceled)

10. The method of claim 1, wherein:
the nanocellulose is present in the nanocellulose composite at a concentration of about 5 weight % to about 10 weight %; and
the copolymer is present in the nanocellulose composite at a concentration of about 1 weight % to about 5 weight %.

11-13. (canceled)

14. The method of claim 1, further comprising combining the nanocellulose composite with nanoclay, nanosilica, or both.

15. A nanocellulose composite comprising a copolymer covalently bonded to a nanocellulose, wherein:
the copolymer is a reaction product of a first monomer, a second monomer, and a third monomer;
the first monomer is a hydrophilic monomer;
the second monomer is a cellulose-reactive monomer; and
the third monomer is an amphiphobic monomer.

16. The nanocellulose composite of claim 15, wherein the first monomer is acrylic ethoxylated ester, methacrylic ethoxylated ester, methacrylate/methacrylate copolymer, itaconic anhydride/methacrylate copolymer, maleic anhydride/methacrylate copolymer, glycidyl acrylate/methacrylate, hydroxylmethyl/hydroxylethyl styrene, or combinations thereof.

17. The nanocellulose composite of claim 15, wherein the second monomer is hydrophobic.

18. The nanocellulose composite of claim 15, wherein the second monomer is an alkoxy silane, a silyl acrylate, acrylic ethoxylated ester, methacrylic ethoxylated ester, methacrylate/methacrylate copolymer, itaconic anhydride/methacrylate copolymer, maleic anhydride/methacrylate copolymer, styrene/substituted styrene, acrylonitrile, vinyl acetate, or combinations thereof.

19. The nanocellulose composite of claim 15, wherein the third monomer is a fluoroalkyl acrylate, 2-trifluoromethyl ethyl acrylate, perfluoro C2-C6 alkyl acrylate, trifluoro ethyl acrylate, trifluorobutyl acrylate, or combinations thereof.

20-23. (canceled)

24. The nanocellulose composite of claim 15, wherein the weight ratio of the nanocellulose to the copolymer is about 1:1 to about 10:1.

25. The nanocellulose composite of claim 15, wherein the nanocellulose composite further comprises nanoclay and/or nanosilica present at a concentration of about 1 weight % to about 5 weight %.

26-40. (canceled)

41. A coated packaging material comprising a substrate at least partially coated with a copolymer covalently bonded to a nanocellulose; wherein:
the copolymer is a reaction product of a first monomer, a second monomer, and a third monomer;
the first monomer is a hydrophilic monomer;
the second monomer is a cellulose-reactive monomer; and
the third monomer is an amphiphobic monomer.

42. The coated packaging material of claim 41, wherein the substrate comprises paper, kraft paper, fabric, or combinations thereof.

43. The coated packaging material of claim 41, wherein the substrate is flexible.

44. The coated packaging material of claim 41, wherein the substrate is fully coated with the copolymer covalently bonded to the nanocellulose.

45. The coated packaging material of claim 41, having a tensile strength of about 40 pounds per square inch (lbs/in²) to about 50 lbs/in² for about 120 pounds (lb) to about 140 lb of weight.
